(19) United States
(12) Patent Application Publication
(10) Pub. No.: US 2009/0303479 A1
(43) Pub. Date: Dec. 10, 2009

(54) Optical Apparatus and Method for the Inspection of Nucleic Acid Probes by Polarized Radiation

(75) Inventors: Francesco Ferrara, Bari (IT); Pier Paolo Pompa, Mesagne (IT); Ross Rinaldi, Lecce (IT)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: STMICROELECTRONICS S.R.L., Agrate Brianza (IT)

(21) Appl. No.: 12/278,267

(22) PCT Filed: Feb. 6, 2006
(86) PCT No.: PCT/IT2006/000061

§ 371 Date: May 20, 2009

(51) Int. Cl. G01N 21/64

(52) U.S. Cl. 356/369

(57) ABSTRACT

An optical apparatus for the inspection of nucleic acid probes includes: a holder (22) for housing a chip (1) for analysis of nucleic acids, containing nucleic acid probes (12, 12′); a light (24), for supplying an excitation radiation (W_{E}) to the holder (22); and an optical sensor (25) for detecting images (IMG) of the nucleic acid probes (12, 12′), when a chip (1) is housed in the holder (22). The light source (24) is configured for polarizing the excitation radiation (W_{E}) according to a excitation polarization direction (D_{E}). Furthermore, the apparatus is provided with a sensing polarizing filter (27), which is arranged so as to intercept a reflected portion (W_{R}) of the excitation radiation (W_{E}), directed towards the optical sensor (25). The sensing polarizing filter (27) has a direction of the sensing polarization (D_{S}) transverse to the excitation polarization direction (D_{E}).

### TECHNICAL FIELD

The present invention relates to an optical apparatus and to a method for the inspection of nucleic acid probes by polarized radiation.

### BACKGROUND ART

As is known, the analysis of nucleic acids requires, according to different modalities, preliminary steps of preparation of a sample of biological material, of amplification of the nucleic material contained therein, and of hybridization of individual target or reference strands, corresponding to the sequences sought. Hybridization occurs (and the test yields a positive outcome) if the sample contains strands complementary to the target strands.

At the end of the preparatory steps, the sample must be examined to control whether hybridization has occurred (the so called detection step). For this purpose, various inspection methods and apparatuses are known, for example of an optical or electrical type. In particular, the methods and apparatuses of an optical type are frequently based upon the phenomenon of fluorescence. The reactions of amplification and hybridization are conducted so that the hybridized strands, contained in a detection chamber made in a support, include fluorescent molecules or fluorofors (the hybridized strands may be either grafted to the bottom of the detection chamber or remain in liquid suspension). The support is exposed to a light source having an appropriate spectrum of emission, such as to excite the fluorofors. In turn, the excited fluorofors emit a secondary radiation at an emission wavelength higher than the peak of the excitation spectrum. The light emitted by the fluorofors is collected and captured by an optical sensor. In order to eliminate the background light radiation, which represents a source of disturbance, the optical sensor is provided with band-pass or interferential filters centred at the wavelength of emission of the fluorofors.

However, the difference between the maximum peak of the emission spectrum of the fluorofors and the peak of the excitation spectrum (also referred to as “Stokes shift”) is not very high, and the filters, however selective they may be, can only attenuate the light emitted by the source and subsequently diffused, without, however, eliminating it altogether. It should also be taken into account that the materials used for providing the supports often have high reflecting power. For example, microfluidic devices for the analysis of nucleic acids integrated in semiconductor chips are increasingly widespread. In integrated microfluidic devices, the detection chamber often has the bottom coated with a layer of silicon dioxide and, sometimes, also metal electrodes are present, for example of gold or aluminium. In effect, hence, only a relatively small part of the light emitted by the source is absorbed, whereas a conspicuous fraction is reflected and is potentially capable of disturbing the detection of the light emitted by the fluorofors.

### DISCLOSURE OF INVENTION

The aim of the present invention is to provide an optical apparatus and a method for the inspection of nucleic acid probes with polarized radiation which will be free from the limitations described.

According to the present invention, an optical apparatus and a method for the inspection of nucleic acid probes are provided, as defined in Claims 1 and 8, respectively.

### BRIEF DESCRIPTION OF THE DRAWINGS

For a better understanding of the invention, some embodiments thereof are now described, purely by way of non-limiting example and with reference to the attached plate of drawings, wherein:

FIG. 1 is a top plan view of a chip for analysis of nucleic acids;

FIG. 2 is a cross-sectional view through the chip of FIG. 1;

FIG. 3 is a simplified block diagram of an optical apparatus in accordance with a first embodiment of the present invention;

FIG. 4 is a schematic illustration of the apparatus of FIG. 3 in use, into which the chip of FIGS. 1 and 2 has been loaded;

FIG. 5 is a graph that shows quantities regarding the apparatus of FIG. 3; and

FIG. 6 is a simplified block diagram of an optical apparatus in accordance with a second embodiment of the present invention.

### BEST MODE FOR CARRYING OUT THE INVENTION

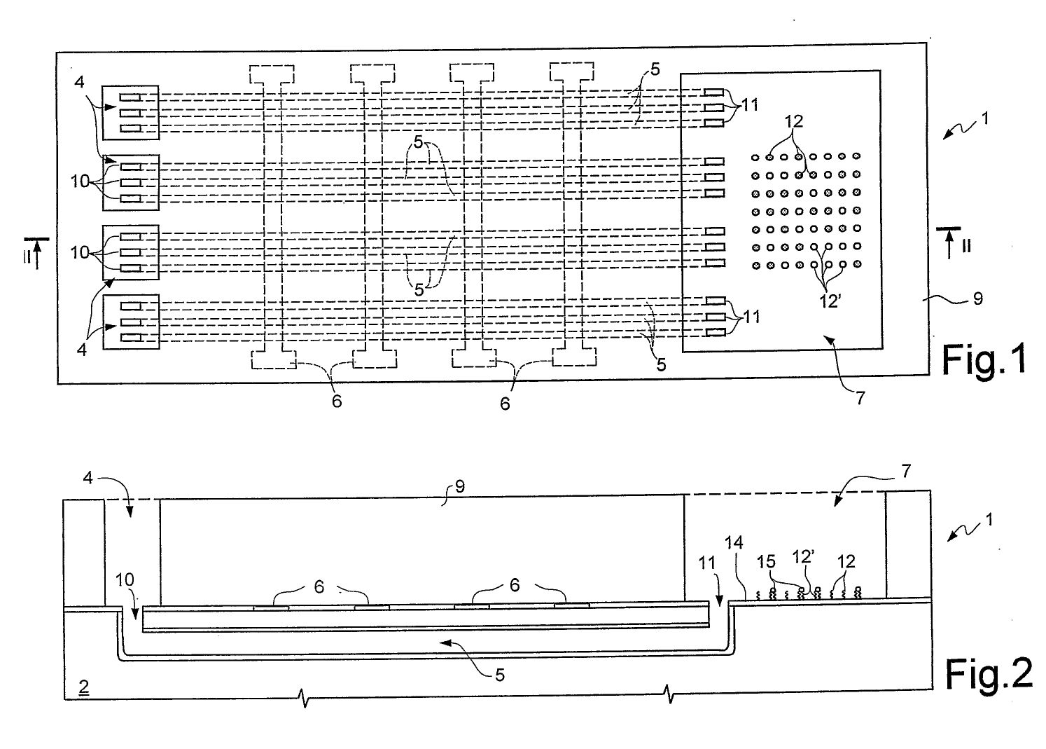

FIGS. 1 and 2 show a chip 1 in which a chemical microreactor for the analysis of nucleic acids (here DNA) is provided. The chip 1 comprises: a substrate 2 made of semiconductor material; inlet reservoirs 4; a plurality of microfluidic channels 5; heaters 6 associated to the microfluidic channels 5; and a detection chamber 7.

More precisely, the inlet reservoirs 4 and the detection chamber 7 are defined in a structural layer 9 arranged on the surface of the substrate 2 (for example, the structural layer 9 may either comprise a resist layer deposited on the substrate 2 or a glass chip glued thereto).

The microfluidic channels 5 are buried within the substrate 2, for example as described in EP-A-1 043 770, EP-A-1 130 631, or in the published patent application US 2005/282221, and extend between the inlet reservoirs 4 and the detection chamber 7. Furthermore, the microfluidic channels 5 are fluidly coupled both to the inlet reservoirs 4, through inlet openings 10, so as to be accessible from outside, and to the detection chamber 7, through outlet openings 11.

The heaters 6, here including resistive elements made of polysilicon, are formed on the surface of the substrate 2 and extend in a direction transverse to the microfluidic channels 5. Furthermore, the heaters 6 are electrically connectable in a known way to external electric power sources (not shown) and can be driven to release thermal power to the microfluidic channels 5 so as to control the temperature within them cyclically according to predetermined thermal profiles.

The detection chamber 7 accommodates a plurality of so called “DNA probes” 12, comprising single stranded reference DNA containing predetermined sequences of nucleotides. More precisely, the DNA probes 12 are arranged in predetermined positions so as to form an array and are grafted to an anchorage layer 14, which forms the bottom of the detection chamber 7. After a step of hybridization, some of the DNA probes, designated by 12′, are hybridized, i.e., they are bound to individual complementary DNA sequences, and contain fluorofors 15.

The microreactor integrated in the chip 1 is prearranged for performing reactions of amplification of nucleic material, for example by PCR (Polymerase Chain Reaction), and hybridization of the DNA probes 12. For this purpose, a biological sample containing nucleic material previously treated is supplied to the inlet reservoirs 4 and fed into the microfluidic channels 5. Here, the sample is subjected to thermal cycling in order to amplify the DNA present, in a known way. At the end of the amplification step, the biological sample is further made to advance as far as the detection chamber 7, where the DNA probes 12 are located. If the biological sample contains a sequence of nucleotides complementary to the DNA probes 12, the latter are hybridized. Furthermore, the amplification reactions are conducted so that the hybridized DNA probes 12′ will contain fluorofors 15 (shown only schematically) having a characteristic emission wavelength.

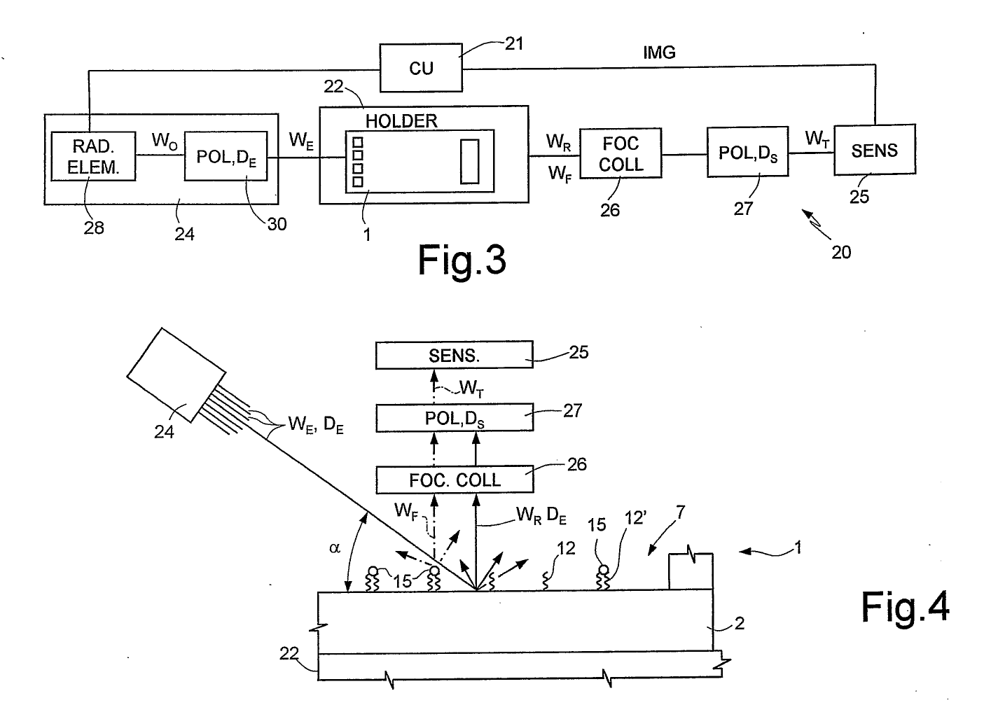

With reference to FIG. 3, number 20 designates an optical inspection apparatus for the detection of hybridized DNA strands, based upon fluorescence. The inspection apparatus 20 comprises a control unit 21, a holder 22 for housing an item of the chip 1, a light excitation device 24 and an optical sensor 25, provided with a collimation and focusing device 26 and a sensing polarizing filter 27. FIG. 3 moreover shows a detail of the chip 1 loaded into the holder 22 so as to be examined.

The light source 24 comprises a radiant element 28, for example an incandescent lamp or a LED, which emits incoherent non-polarized radiation W₀ with an emission spectrum such as to excite the fluorofors 15, and an excitation polarizing filter 30 associated to the radiant element 28. The excitation polarizing filter 30, of a linear type, is positioned so as to intercept the non-polarized radiation W₀ emitted by the radiant element 28 and has a predetermined excitation polarization direction D_{E} (i.e., the radiation emerging from the excitation polarizing filter 30 is polarized according to the excitation polarization direction D_{E}). Consequently, the excitation radiation W_{E} that leaves the light source 24 is linearly polarized according to the excitation polarization direction D_{E}.

The light source 24 is moreover oriented so that the excitation radiation W_{E} reaches the detection chamber 7 of the chip 1 with a predetermined angle of incidence (for example 45°).

The optical sensor 25, for example of a CMOS or CCD type, receives the fluorescent radiation W_{F} emitted by the fluorofors 15 in the detection chamber 7 of the microreactor integrated in the chip 1. More precisely, the collimation and focusing device 26 is arranged so as to collect the fluorescent radiation W_{F} emitted in a direction substantially perpendicular to the chip 1 and orient it in the direction of the optical sensor 25.

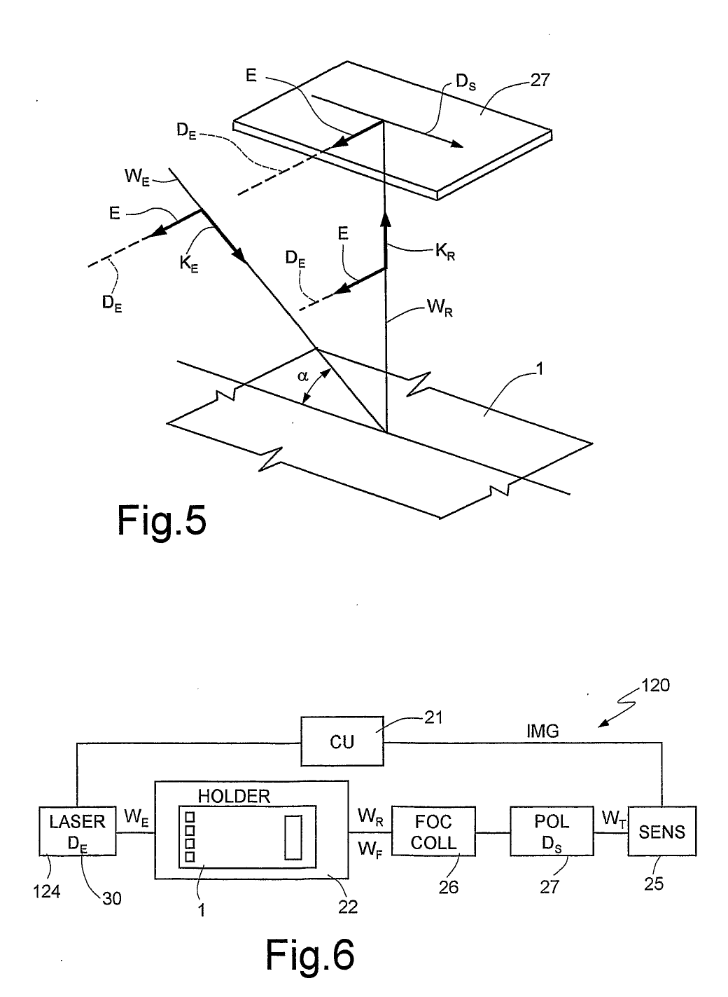

The sensing polarizing filter 27, which is also of a linear type, is positioned between the collimation and focusing device 26 and the optical sensor 25 so as to intercept the fraction of excitation radiation W_{E} coming from the light source 24 and reflected or diffused by the chip 1 in the direction of the optical sensor 25 (reflected radiation W_{R}; for reasons of convenience, the term “reflected radiation” will be used hereinafter to indicate both the fraction of radiation incident on the chip 1 that is reflected according to a macroscopically predictable path and the fraction of incident radiation that is diffused in the direction of the optical sensor 25, for example on account of the imperfect homogeneity of the surface of the chip 1). The sensing polarizing filter 27 has a sensing polarization direction D_{S} that is transverse, preferably perpendicular, to the excitation polarization direction D_{E} of the reflected radiation W_{R}. In this connection (see FIG. 5), the reflection does not modify substantially the direction of the electric field E associated to the excitation radiation (parallel to the excitation polarization direction D_{E}), whereas the direction of propagation K_{R} of the reflected radiation W_{R} is determined by the surface conformation of the chip 1 (as well as, of course, by the direction of propagation K_{E} of the incident excitation radiation), according to the laws of geometrical optics. A part of the reflected radiation W_{R} is thus directed towards the optical sensor 25 along an optical path P. The sensing polarizing filter 27 is arranged along the optical path P in a plane substantially perpendicular to the direction of propagation K_{R} of the reflected radiation W_{R} directed towards the optical sensor 25. The sensing polarization direction D_{S} of the sensing polarizing filter 27 is perpendicular to the excitation polarization direction D_{E} (i.e., perpendicular to the direction of the electric field E associated to the reflected radiation W_{R}). Preferably, moreover, the orientation of the sensing polarizing filter 27 is adjustable so as to achieve the most correct alignment.

The inspection apparatus 20 operates as described hereinafter. Initially, an item of the chip 1, integrating a microreactor in which a step of hybridization of the DNA probes 12 has been performed, is loaded into the holder 22. The control unit 21 activates the light source 24, and the excitation radiation W_{E} emitted reaches the detection chamber 7. A fraction of the excitation radiation W_{E} incident on the chip 1 is absorbed by the fluorofors 15 of the hybridized DNA probes 12′, whereas the remaining part is reflected or diffused in various directions, according to the surface conformation of the chip 1. The fluorofors 15 are hence excited and emit in an approximately isotropic way an fluorescent radiation W_{F}, which does not preserve the state of polarization of the excitation radiation W_{E}.

Consequently, a part of the fluorescent radiation W_{F} and the reflected or diffused radiation W_{E} directed towards the optical sensor 25 reach the sensing polarizing filter 27, which is located in front of the optical sensor 25. The reflected radiation W_{R} is intercepted and almost completely blocked by the sensing polarizing filter 27, because it is polarized in a direction substantially perpendicular to the sensing polarization direction D_{S}. In particular, the effectiveness of the sensing polarizing filter 27 is higher the closer the sensing polarization direction D_{S} is to being perpendicular to the polarization direction of the reflected radiation W_{R} (i.e., the excitation polarization direction D_{E}). The fluorescent radiation W_{F} due to the excitation of the fluorofors 15, instead, is in part attenuated, but not eliminated completely (transmitted radiation W_{T}), and can hence reach the optical sensor 25, which detects an image IMG and sends it to the control unit 21.

Advantageously, the sensing polarizing filter 27 enables practically total elimination of the excitation radiation emitted by the light source 24 and reflected by the chip 1, which represents a disturbance. Consequently, the images detected by the optical sensor 25 are produced substantially only by the fluorescent radiation and enable detection of the hybridized DNA probes 12′ in an extremely reliable way.

A different embodiment of the invention is illustrated in FIG. 6, where parts that are the same as those already shown are designated by the same reference numbers. In this case, an optical inspection apparatus 20 for the detection of hybridized DNA strands, based upon fluorescence, comprises the control unit 21, the holder 22, a light source 124, the optical sensor 25, the collimation and focusing device 26, and the sensing polarizing filter 27.

The light source 124 comprises an emitter element 130, which generates directly a coherent monochromatic excitation radiation W_{E}, polarized according to a excitation polarization direction D_{E} (for example, a laser emitter). The emission is spontaneously polarized, and the use of biasing filters associated to the light source 124 is not required.

The sensing polarizing filter 27 is once again oriented so that the sensing polarization direction D_{S} is substantially perpendicular to the polarization direction of the reflected radiation W_{R}, which is in practice the excitation polarization direction D_{E}.

Hence, as has already been described, the reflected radiation W_{R} is blocked by the sensing polarizing filter 27, and only the fluorescent radiation W_{E} emitted by the fluorofors 15 is transmitted to the optical sensor 25.

Finally, it is evident that modifications and variations may be made to the apparatus and method described herein, without departing from the scope of the present invention, as defined in the annexed claims.

1. An optical apparatus for the inspection of nucleic acid probes, comprising:
a holder for receiving a chip for analysis of nucleic acids, containing nucleic acid probes;
a light excitation device for supplying an excitation radiation to said holder, wherein said excitation radiation is polarized according to a first polarization direction;
an optical sensor for detecting images of said nucleic acid probes when said chip is housed in said holder; and
a sensing polarizing filter having a second polarization direction transverse to said first polarization direction and arranged so as to intercept a reflected portion of said excitation radiation directed towards said optical sensor.

2. The apparatus according to claim 1, wherein said second polarization direction is substantially perpendicular to said first polarization direction.

3. The apparatus according to claim 1, wherein said light excitation device comprises a radiant element supplying a non-polarized radiation and an excitation polarizing filter for polarizing said non-polarized radiation according to said first polarization direction.

4. The apparatus according to claim 1, wherein said light excitation device comprises a polarized radiation emitter element.

5. The apparatus according to claim 4, wherein said polarized radiation emitter element is a laser emitter.

6. The apparatus according to claim 1, wherein said light excitation device is oriented so that said excitation radiation reaches said chip with an angle of incidence of approximately 45°.

7. The apparatus according to claim 1, comprising a collimation and focusing device arranged so as to collect a fluorescent radiation emitted by said nucleic acid probes in a direction substantially perpendicular to said chip and to orient said fluorescent radiation collected towards said optical sensor.

8. A method for the inspection of nucleic acid probes, comprising the steps of:
sending an excitation radiation to a chip containing nucleic acid probes, wherein said excitation radiation is polarized according to a first predetermined direction; and
filtering a reflected portion of said excitation radiation with a polarizing filter, wherein said polarizing filter has a second polarization direction that is transverse to said first polarization direction.
